(19) United States
(12) Patent Application Publication
(10) Pub. No.: US 2010/0115026 A1
(43) Pub. Date: May 6, 2010

(54) CONTENT DISTRIBUTION SYSTEM AND METHOD, AND SERVER DEVICE, AND CLIENT DEVICE

(75) Inventors: Keiji Katata, Tokorozawa-Shi (JP); Takeshi Koda, Tokorozawa-Shi (JP); Nobuyuki Takakuwa, Tokorozawa-Shi (JP); Masayoshi Yoshida, Tokorozawa-Shi (JP); Masahiro Kato, Tokorozawa-Shi (JP)

Correspondence Address: YOUNG & THOMPSON, 209 Madison Street, Suite 500, Alexandria, VA, 22314, US

(73) Assignee: PIONEER CORPORATION, TOKYO (JP)

(21) Appl. No.: 12/593,378

(22) PCT Filed: Mar. 29, 2007
(86) PCT No.: PCT/JP2007/056938

§ 371 Date: Dec. 28, 2009

(51) Int. Cl. G06F 15/16

(52) U.S. Cl. 709/203

(57) ABSTRACT

A content distribution system (100) includes a server device (3) and a client device (2) which are contained in a network (17), and an information recording medium (1) capable of being set in the client device and recordable. The client device, when the information recording medium on which prepaid information or content identification information is recorded is set, transmits the recorded information to the server device. The server device distributes the contents corresponding to the content identification information to the client device within the prepaid range indicated by the prepaid information. The client device stores the contents to be distributed in a storage element (9) and further copies them to the information recording medium. With this, content distribution excellent in promptness and safety can be achieved and also an information recording medium on which desired contents are recorded can be safely and surely delivered to the user's hand.

### TECHNICAL FIELD

The present invention relates to a content delivery system and method, which delivers or distributes content from a server apparatus to a client apparatus through a network such as the Internet. The present invention also relates to the server apparatus and the client apparatus which constitute such a content delivery system.

### BACKGROUND ART

As this type of system, for example, there is a system for delivering content such as films, drama, and sports programs, to a personal computer equipped with a HDD (Hard Disc Drive) and a HDD built-in optical disc recorder. If there is a charge for such a delivery, it is charged in a form of corresponding directly to the delivery, by payment on credit or the like. For example, in a patent document 1, there has been suggested a technology to be performed without complicating the charge even if the delivered paid content is reproduced in various types of environments in such a content delivery system.

Patent Document 1: Japanese Patent Application Laid. Open No. 2005-190175

### DISCLOSURE OF INVENTION

### Subject to be Solved by the Invention

However, in the aforementioned background art, for example, highly-confidential information, such as a credit-card number, a change ID (Identifier), a password, and a bank account, is inputted in the payment through the network. Thus, the charge process corresponding to the content delivery is not suitable for a person (e.g. a grandchild, a child) other than oneself (e.g. a grandfather, a father) to perform, which is technically problematic. Thus, in the background art, it is not easy to use the content delivery and to present the content to the person other than oneself.

In addition, it takes a long time if it is tried to directly download the content to be delivered, onto an optical disc represented by a DVD, a BD (Blu-ray Disc), and the like which are generally spread. This results in a dramatic increase in the likelihood of the occurrence of an error during the download; namely, this possibly causes a miswritten optical disc in the end, which is technically problematic.

On the other hand, there has been also a widely spread service to deliver or mail an optical disc with such one content being recorded that is specified by a user who has watched advertisement of various films, drama, and the like on the network. In this case, although there is no problem of the error occurrence during the charge and the download as described above, it is far from taking advantage of the high-speed delivery technology using the network.

In view of the aforementioned problems, it is therefore an object of the present invention to provide such a content delivery system and method that use a prepaid information recording medium on which the charge process is performed without inputting the highly-confidential information and which prevents content from being miswritten due to the download that requires a long time, as well as a server apparatus and a client apparatus.

### Means for Solving the Subject

The above object of the present invention can be achieved by a content delivery system provided with a server apparatus and a client apparatus which are included in a network; and an information recording medium which can be set on the client apparatus and which allows recording, wherein prepaid information is recorded on the information recording medium, the prepaid information indicating at least one of a prepaid amount of money to obtain content and an indication that it has been prepaid, the client apparatus transmits the recorded prepaid information and content identification information indicating the content to the server apparatus when the information recording medium is set, the server apparatus delivers the content indicated by the transmitted content identification information to the client apparatus in a prepaid range indicated by the transmitted prepaid information, and the client apparatus stores the delivered content into a storing device and further copies the stored content onto the information recording medium.

According to the content delivery system of the present invention, the network such as the Internet includes the server apparatus for delivering films, drama, and the like; and the client apparatus such as a hard disk built-in optical disc recorder or the like. Moreover, the information recording medium, such as an optical disc, for example, a DVD, a BD, or the like, and various memories of a portable type, can be set on the client apparatus.

Here, a user who desires to obtain the content for oneself or as a present prepays the content. Specifically, the user obtains the information recording medium by paying a prepaid amount of money or a slightly added or reduced price, in store sales or mail-order sales, in cash or on credit. Here, “to obtain the content” means that the delivery of specified or unspecified content is received on the client apparatus with the information recording medium set, that the received content is temporarily stored into the storing device provided for the client apparatus, and that the stored content is copied onto the information recording medium from the storing device (and that the information recording medium is arbitrarily reproduced as its own belonging after the copying, or the like). Therefore, the “prepaid amount of money to obtain the content” is an amount of consideration or compensation to purchase a right to receive the delivery of content and to store the content, and a right to copy the content, as described above. In other words, the user makes prepayment under a contract to purchase the information recording medium as well as the delivery, storage and copy rights. Incidentally, a right to directly reproduce the content from the storing device on the client apparatus may be a target for prepaid purchase. Alternatively, the right to directly reproduce the content may be removed from the purchase target, or it may be the purchase target selectively (i.e. by giving a different in amount of money).

The prepaid information is recorded on the information recording medium, wherein the prepaid information indicates at least one of the prepaid amount of money and the indication that it has been prepaid. Here, the content that a user desires to purchase may be arbitrary one of the content information which can be delivered on the server apparatus side. Alternatively, it may be one or a plurality of contents linked to the information recording medium. As for the linked plurality of contents, for example, they may be limited to contents for children. Alternatively, contents for adults may be eliminated, or the linked contents may be limited to the works of a certain movie distribution company or a particular series. Such an information recording medium is typically of a write-once type; however, it may be partially pre-recorded by embossed pits or the like, and moreover, it may be partially or entirely rewritable.

After that, the information recording medium is set on the client apparatus installed at home, at an exclusive-use facility, or the like, by a user who physically obtains the information recording medium (e.g. a grandfather, a father, or the like) or by a user who takes over it from him (e.g. a grandchild, a child, or the like). Then, on the client apparatus, the recorded prepaid information and the content identification information indicating the content are transmitted to the server apparatus through the network.

Then, in response to the transmission, on the server apparatus, the content indicated by the transmitted content identification information is delivered to the client apparatus in the prepaid range indicated by the transmitted prepaid information. The “prepaid range” herein means a range of prepaid amount of money, or a range of specified or unspecified content corresponding to prepayment. For example, in accordance with the transmitted prepaid information, if the content whose price is out of the range of prepaid amount of money is identified (i.e. the delivery of the content is requested), or if the prepaid amount of money is not left, or if the prepaid amount of money has been used, the content is not delivered. On the other hand, in accordance with the transmitted prepaid information, if the content whose price is in the range of prepaid amount of money is identified, or if the prepaid amount of money is sufficient to deliver the content, the content is delivered to the client apparatus through the network.

Then, in response to this, on the client apparatus, firstly, the delivered content is stored into the storing device, such as a hard disk and a semiconductor memory. The storage is preferably performed at a high writing speed suitable for a delivery speed through the network, from the viewpoint of reducing a network connection time. In any cases, when the delivery is received, the content is not directly stored, or not recorded, or not copied on the information recording medium.

Continuously after or next time which is some time after the delivery and the storage are performed, the content as stored above is copied onto the information recording medium, such as an optical disc, on the client apparatus. The copying may be performed at a writing speed lower than the delivery speed.

As a result, a user receives the delivery of the specified or unspecified content, and moreover, the user can purchase the right to copy the content by prepayment. At this time, the content can be transferred by virtue of the delivery through the network, quickly and easily. Thus, as compared to a case where an information recording medium on which specified content has been recorded is delivered or mailed in response to a user's request, it is extremely excellent in efficiency, the degree of freedom, and quickness in the delivery. In particular, at the prepaid stage, the content can be arbitrary, so that it is extremely useful when the content is given to another person (e.g. a grandchild) as a present. In addition, it is also extremely easy to limit the content that can be delivered. Thus, it is possible to prevent children from purchasing films for adult.

Moreover, payment can be made in a form of being separated from the delivery operation (e.g. payment in cash at a store or credit payment). Thus, the upper limit of the payment amount is determined firmly as the prepaid amount of money when the information recording medium is physically obtained. Thus, as compared to a case where payment is made by a credit card or the like as a part of the delivery request, it is extremely excellent in safety in terms of business deals. Typically, even if the information recording medium associated with prepayment is given to an irresponsible child, there is no problem beyond the prepaid upper limit.

In addition, when the delivery and the storage of the content are not completely performed, the delivery and the storage are performed one more time or a plurality of times, thereby completely performing the delivery and the storage. Then, the copying can be performed on the information recording medium. Thus, in view of a probability that a communication error on the network occurs in the middle of the delivery of the content, it is remarkably useful when the writing speed in the copying is slower than the delivery speed and a storage speed, or when the information recording medium which is a copying destination is of a write-once type which allows only one recording. In other words, in general, in the case of the low writing speed or the information recording medium which does not allow rewriting, the probability that the communication error causes miswriting remarkably increases when it is tried to directly write the content delivered through the network; namely, the miswriting damages the information recording medium. In the present invention, however, the temporal storage of the content into the storing device remarkably reduces the probability that the miswriting occurs. Moreover, in this sense, the copying onto the information recording medium is desirably performed after the storage into the storing device is completely ended.

As described above, according to the content delivery system of the present invention, it is possible to perform the business deals excellent in quickness and safety, and it is also possible to ensure that the information recording medium with the desired content recorded is safely delivered to a user.

In one aspect of the content delivery system of the present invention, the client apparatus stores the delivered content into the storing device and can reproduce the stored content.

In one aspect of the content delivery system of the present invention, the server apparatus allows the client apparatus through the network to copy the stored content onto the information recording medium.

According to this aspect, it is not until the copying is allowed by the server apparatus by a unit of the information recording medium and by a unit of the client apparatus that the content stored in the storing device on the client apparatus on which the information recording medium is set can be copied onto the information recording medium. Thus, even if it is tried to perform the copying illegally (i.e. without fulfilling the contract associated with the prepayment) on the client apparatus, this can be prevented by management control from the server apparatus side through the network. Incidentally, the server apparatus may allow the direct reproduction of the content, in addition to the copying from the storing device.

In another aspect of the content delivery system of the present invention, medium identification information about the information recording medium is recorded on the information recording medium, the client apparatus further transmits the recorded medium identification information to the server apparatus, and the server apparatus delivers the content if the information recording medium identified in accordance with the transmitted medium identification information is an information recording medium registered as what allows at least delivery of the content in advance out of the delivery of the content and copying of the content, and the server apparatus allows the client apparatus through the network to copy the stored content onto the information recording medium.

According to this aspect, not only the prepaid information but also the medium identification information unique to the information recording medium, such as download information like a disc ID, EST (Electronic Sell Through) session information, or the like, are recorded on the information recording medium. The medium identification information indicates that the copying of the content is allowed in advance, and the indication is registered in advance in each piece of medium identification information on the server apparatus side which distributes the information recording medium. In other words, in the case of the information recording medium indicated by the medium identification information registered as being prepaid, it is seen that it has been prepaid by referring to the medium identification information, even after the distribution or sales of the information recording medium.

After that, when the information recording medium is set on the client apparatus, the medium identification information is transmitted to the server apparatus through the network, in addition to the recorded prepaid information and the content identification information indicating the content. Then, in response to the transmission, on the server apparatus, if the information recording medium identified in accordance with the medium identification information is the information recording medium registered as what allows the copying of the content in advance, the content is delivered to the client apparatus. Moreover, it is not until the copying is allowed by the server apparatus that the content stored in the storing device can be copied onto the information recording medium on the client apparatus on which the information recording medium is set. On the other hand, if the identified information recording medium is not the information recording medium registered in advance, the copying is not allowed. Thus, even if it is tried to perform the copying illegally on the client apparatus, this can be prevented by the management control from the server apparatus side through the network.

In another aspect of the content delivery system of the present invention, medium identification information about the information recording medium is recorded on the information recording medium, the client apparatus further transmits the recorded medium identification information to the server apparatus, and the server apparatus delivers the content if the information recording medium identified in accordance with the transmitted medium identification information is an information recording medium registered as what allows at least the delivery of the content in advance out of the delivery of the content and copying the content.

According to this aspect, not only the prepaid information but also the medium identification information unique to the information recording medium such as the download information like a disc ID, EST session information, or the like, are recorded on the information recording medium. The medium identification information indicates that the delivery of the content is allowed in advance, and the indication is registered in advance in each piece of medium identification information on the server apparatus side which distributes the information recording medium.

After that, when the information recording medium is set on the client apparatus, the medium identification information is transmitted to the server apparatus through the network, in addition to the recorded prepaid information and the content identification information indicating the content. Then, in response to the transmission, on the server apparatus, if the information recording medium identified in accordance with the medium identification information is the information recording medium registered as what allows the delivery of the content in advance, the content is delivered to the client apparatus. On the other hand, if the identified information recording medium is not the information recording medium registered in advance, the delivery is not performed. Thus, even if the delivery of the content is illegally requested, this request can be certainly denied in accordance with the medium identification information on the server apparatus.

In an aspect in which the medium identification information is transmitted, as described above, the medium identification information may include delivery control information indicating at least one of an indication that the content has been delivered and an indication that the content has been copied.

By virtue of such construction, on the server apparatus side, it can be seen that the content has been delivered and that the content has been copied, by referring to the medium identification information. Thus, on the client apparatus, even if it is tired to perform the copying illegally such as performing the copying again onto another information recording medium after performing the copying once, this can be prevented by the management control from the server apparatus side through the network.

Incidentally, if at least the delivery of the content can be performed in accordance with the delivery control information, the server apparatus may deliver the content and may allow the client apparatus through the network to copy the stored content onto the information recording medium. Alternatively, if the delivery of the content can be performed in accordance with the delivery control information, the server apparatus may deliver the content. Alternatively, if the delivery of the content can be performed in accordance with the delivery control information, the client apparatus may transmit the prepaid information and the content identification information to the server apparatus.

In another aspect of the content delivery system of the present invention, a plurality of advertisement information according to the content is recorded on the information recording medium, and the client apparatus can specify the content by specifying one or a plurality of advertisement out of the recorded plurality of advertisement information.

In this aspect, a user firstly can watch the plurality of advertisement information recorded on the information recording medium on the client apparatus, and among them, one or a plurality of advertisement information are specified through a keyboard, a remote controller switch, or the like. By this, the user can specify the content the user desires to obtain. Thus, if the content identification information indicating the content specified in this manner is transmitted to the server apparatus, the user can obtain the desired content after watching the advertisement information, so that it is extremely useful in practice.

Incidentally, regardless of the presence of the advertisement information, the client apparatus may be capable to specify the content. In this case, with respect to the individual information recording medium, the content may be limited to one or more than one.

In another aspect of the content delivery system of the present invention, the client apparatus can update the recorded prepaid information in accordance with the delivery of the content.

According to this aspect, the recorded prepaid information is updated on the client apparatus, in accordance with the delivery of the content, and typically in accordance with the delivery of the content by the prepaid amount with respect to the information recording medium and the copying associated with the delivery. Here, “update” means to change an amount of money indicated by the prepaid information to zero, or to reduce it, or change the amount into a status indicating that the prepaid amount of money has been used. Thus, even if the same information recording medium is set, it is possible to perform the delivery and the copy control, which vary depending on after or before the right obtained by prepayment is excised, on the client apparatus by referring to the updatable prepaid information recorded on the information recording medium.

In another aspect of the content delivery system of the present invention, the server apparatus controls the client apparatus through the network to update the recorded prepaid information in accordance with the delivery of the content.

According to this aspect, on the client apparatus, the recorded prepaid information is updated in accordance with the delivery of the content. Thus, even if the same information recording medium is set, it is possible to perform the management control for the client apparatus, which varies depending on after or before the right obtained by prepayment is excised, on the server apparatus by referring to the updatable prepaid information recorded on the information recording medium.

In another aspect of the content delivery system of the present invention, medium identification information about the information recording medium is recorded on the information recording medium, the client apparatus further transmits the recorded medium identification information to the server apparatus if copying of the content onto the information recording medium has failed, in a form of including failure information indicating that the copying has failed, and the server apparatus forbids the client apparatus through the network to copy the stored content onto the information recording medium identified by the medium identification information if the copying has failed in accordance with the failure information in the transmitted medium identification information, and the server apparatus allows the client apparatus through the network to copy the stored content onto another information recording medium.

According to this aspect, when the content is delivered from the server apparatus to the client apparatus, the content is stored into the storing device on the client apparatus, and the content is further copied onto the information recording medium. In particular, the copying onto the information recording medium has failed, the medium identification information is included in the failure information which indicates that the copying has failed, and it is transmitted to the server apparatus. The “failure” means that so-called miswriting occurs for some reasons in any of the processes from the delivery to the completion of the copying of the content, with regard to a part or all of the content to be copied.

Then, in response to the transmission of the medium identification information, it is forbidden by the server apparatus to copy the content stored in the storing device onto the information recording medium identified in accordance with the medium identification information. In return, it is allowed by the server apparatus to copy the content stored in the storing device onto another information recording medium different from the information recording medium identified in accordance with the medium identification information.

Therefore, even if the right to copy the content obtained by prepayment is not exercised for some reasons, it is possible to respond to the case, quickly and easily. For example, it is possible to easily respond to a complaint from a user that the copying has failed. In particular, if the storage into the storing device has succeeded, the copying onto another information recording medium from the storing device can be performed without a necessity to perform the delivery of the content again, so that it is extremely efficient.

In addition, by adopting the construction that the medium identification information about another information recording medium is referred to on the server apparatus, even if requests for the delivery and copying which cause illegal duplication (i.e. which is beyond the prepaid range) are made, the server apparatus can also prevent relatively easily such an illegal activity. In other words, it is possible to allow the copying onto one information recording medium and forbid the copying onto second and subsequent information recording media.

The above object of the present invention can be also achieved by a content delivery method in a content delivery system provided with a server apparatus and a client apparatus which are included in a network; and an information recording medium which can be set on the client apparatus and which allows recording, wherein prepaid information is recorded on the information recording medium, the prepaid information indicating at least one of a prepaid amount of money to obtain content and an indication that it has been prepaid, and the content delivery method is provided with: a transmitting process of transmitting the recorded prepaid information and content identification information indicating the content to the server apparatus when the information recording medium is set, on the client apparatus; a delivering process of delivering the content indicated by the transmitted content identification information to the client apparatus in a prepaid range indicated by the transmitted prepaid information, on the server apparatus; a storing process of storing the delivered content into a storing device, on the client apparatus; and a copying process of copying the stored content onto the information recording medium, on the client apparatus.

According to the content delivery method of the present invention, as in the case of the content delivery system of the present invention described above, it is possible to perform the business deals excellent in quickness and safety, and it is also possible to ensure that the information recording medium with the desired content recorded is safely delivered to a user.

Incidentally, even the content delivery method of the present invention can adopt the same various aspects as those in the content delivery system of the present invention described above, as occasion demands.

The above object of the present invention can be also achieved by the server apparatus in the aforementioned content delivery system (including its various aspects).

According to the server apparatus of the present invention, as in the case of the content delivery system of the present invention described above, it is possible to perform the business deals excellent in quickness and safety, and it is also possible 0 ensure that the information recording medium with the desired content recorded is safely delivered to a user.

The above object of the present invention can be also achieved by the client apparatus in the aforementioned content delivery system (including its various aspects).

According to the client apparatus of the present invention, as in the case of the content delivery system of the present invention described above, it is possible to perform the business deals excellent in quickness and safety, and it is also possible to ensure that the information recording medium with the desired content recorded is safely delivered to a user.

These operation and other advantages of the present invention will become more apparent from the embodiment explained below.

As explained above in details, according to the content delivery system of the present invention, it is provided with the server apparatus, the client apparatus, and the information recording medium. According to the content delivery method of the present invention, it is provided with the transmitting process, the delivering process, the storing process, and the copying process. According to the server apparatus of the present invention, it delivers the content to the client apparatus in the prepaid range. According to the client apparatus of the present invention, it stores the delivered content into the storing device and copies the content. Thus, it is possible to perform the business deals excellent in quickness and safety, and it is also possible to ensure that the information recording medium with the desired content recorded is safely delivered to a user.

### BRIEF DESCRIPTION OF DRAWINGS

FIG. 1 is a system structure diagram showing the outline of a content delivery system in an embodiment.

FIG. 2 is a data structure diagram showing various data recording areas of an information recording medium in the embodiment.

FIG. 3 is a flowchart showing a content obtainment process in the embodiment.

FIG. 4 is a flowchart showing a content obtainment process with advertisement watching in the embodiment.

FIG. 5 is a flowchart showing a miswriting correspondence content obtainment process in the embodiment.

### DESCRIPTION OF REFERENCE CODES

1 optical disc
2 personal computer
3 content delivery server
17 Internet
100 content delivery system

### BEST MODE FOR CARRYING OUT THE INVENTION

Hereinafter, an embodiment of the present invention will be described with reference to the drawings.

### Embodiment

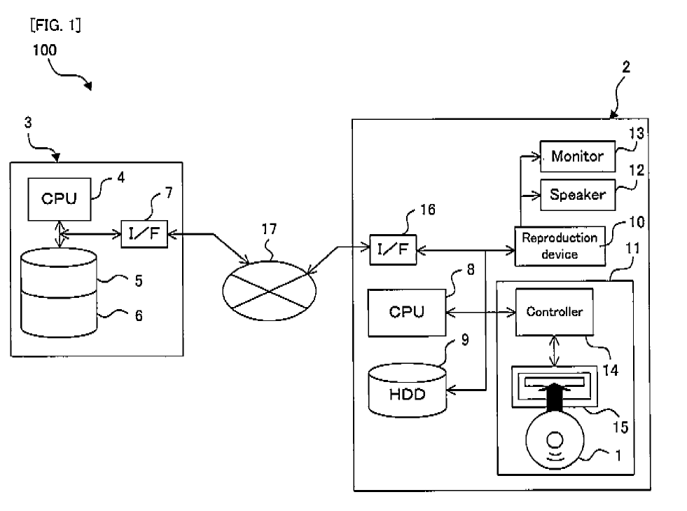

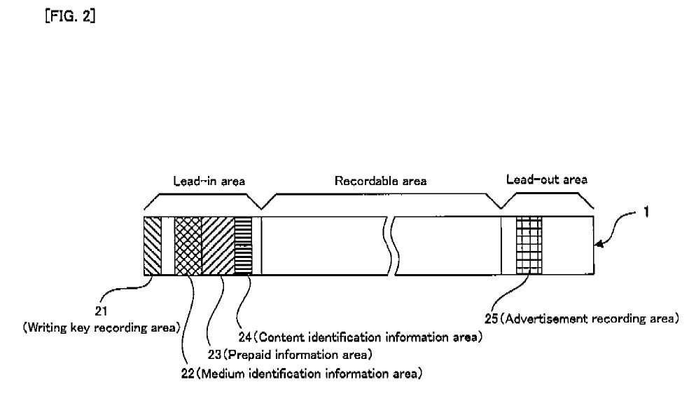

Firstly, a content delivery system in the embodiment will be described with reference to FIG. 1 and FIG. 2. FIG. 1 is a system structure diagram showing the content delivery system in the embodiment. FIG. 2 is a data structure diagram showing an information recording medium in the embodiment.

In FIG. 1, a content delivery system 100 in the embodiment is provided mainly with an optical disc 1, a personal computer 2, and a content delivery server 3. The personal computer 2 and the content delivery server 3 are connected to the Internet 17, and data can be transmitted and received through the Internet 17.

The optical disc 1 is, for example, a DVD, a BD, or the like as one example of the “information recording medium” in the embodiment. The optical disc 1 is set on an optical drive 11 of the personal computer 2, and content such as films and drama can be recorded thereon.

As shown in FIG. 2, the optical disc 1 is provided with a writing key recording area 21, a medium identification information area 22, a prepaid information area 23, and a content identification information area 24, which are located in a lead-in area, and an advertisement recording area 25, which is located in a lead-out area.

In the writing key recording area 21, a writing key is recorded. The writing key allows content to be written into a recordable area on the optical disc 1. In the embodiment, the writing key is generated by the content delivery server 3, with the delivery of content. The writing key may be encrypted in existing various encryption methods.

In the medium identification information area 22, medium identification information is recorded. The medium identification information includes, for example, a disc ID, delivery control information, or the like. The disc ID identifies the optical disc 1. The delivery control information is updated by a CPU 8 in accordance with the delivery and copying of content. Specifically, in response to the normal delivery of content, such an indication is recorded that the content has been already delivered, and in response to the copying of content, an indication is recorded that the content has been already copied, and therefore the delivery control information or the like is updated.

In the prepaid information area 23, prepaid information is recorded. The prepaid information is updated by the CPU 8 in accordance with the delivery of content, as in the delivery control information. Specifically, before the delivery of content, a prepaid amount of money to obtain the content is recorded, and in accordance with the normal delivery of content, such an indication is recorded that the prepaid amount of money has been used, and therefore the prepaid information is updated.

In the content identification information area 24, content identification information is recorded. The content identification information indicates a content identification number for identifying the obtained content.

Incidentally, at least one portion of the disc ID, the delivery control information, the prepaid information, and the content identification information described above may be formed of or include existing EST session information which manages a relation between the delivery and the content, with regard to electronic sales through a session.

In the advertisement recording area 25, a plurality of advertisement information is recorded. The plurality of advertisement information can be watched by a user, and moreover, one or a plurality of advertisement information is specified by a user's keyboard operation or the like. By this, the content that a user desires to obtain is specified, and the specified content plays a role as the content identification information.

The personal computer 2 is provided mainly with the CPU 8, a HDD 9, a reproduction device 10, the optical drive 11, and an interface 16, as one example of the “client apparatus” in the embodiment. The personal computer 2 receives the content delivered by the content deliver server 3.

The CPU 8 is connected to each device of the personal computer 2. The CPU 8 controls the reproduction device 10 to reproduce the content stored in the HDD 9, and it controls the optical drive 11 to perform reading and writing on the set optical disc 1.

The reproduction device 10 is connected to a speaker 12 and a monitor 13, and it uses them to reproduce the content in the HDD 9.

The optical drive 11 is provided with a controller 14 and a reading/writing device 15. The controller 14 operates the reading/writing device 15 with respect to the set optical disc 1, thereby reading the medium identification information, the prepaid information and the content identification information which are recorded in the lead-in area of the optical disc 1. Moreover, the optical drive 11 writes the content stored in the HDD 9, into the recordable area of the optical disc 1, thereby copying the content.

The CPU 8 transmits the various information read by the optical drive 11, to the content delivery server 3 through the interface 16. Moreover, in response to the transmission of the various information, the CPU 8 stores the content delivered from the content deliver server 3 into the HDD 9 and further controls the optical drive 11 to copy the content stored in the HDD 9 onto the optical disc 1, wherein the operation of the CPU 8 is regulated or controlled by the content delivery server 3 in the copying of the content.

The CPU 8 updates the delivery control information as the medium identification information in accordance with the delivery and copying of content, and it updates the prepaid information in accordance with the delivery of content.

The content delivery server 3 is provided with a CPU 4, a disc information database 5, a content database 6, and an interface 7, as one example of the “server apparatus” in the embodiment. The content delivery server 3 receives the medium identification information, the prepaid information and the content identification information which are recorded on the optical disc 1, which are transmitted from the personal computer 2.

The disc information database 5 stores a plurality of disc IDs which are added to a plurality of optical discs on which the delivery and copying of content are allowed.

The content database 6 stores a plurality of contents. Each of the contents is linked to one piece of content identification information.

The CPU 4 is connected to each device of the content delivery server 3. In the delivery of content, the CPU 4 firstly accesses the disc information database 5 and judges whether or not a transmitted disc ID is registered in the disc information database 5. The ID of the optical disc 1 distributed to a disc shop or the like is registered in the disc information database 5 before the distribution. Alternatively, the ID of the optical disc 1 distributed to a disc shop or the like is registered in the disc information database 5 through the network 17 when prepaid processing is implemented at the shop or the like. Thus, when the CPU 4 performs the judgment, the disc ID is registered in the disc information database 5 in the case of the legally prepaid optical disc 1.

The CPU 4 also judges which indication the transmitted delivery control information gives, the delivery of content or undelivery. Moreover, from the transmitted prepaid information, the CPU 4 judges whether or not the content corresponding to the transmitted content identification number can be delivered in a range of prepaid amount of money.

From the aforementioned three judgment results, if the disc ID is registered in the disc information database 5, the delivery control information indicates undelivery, and the corresponding content can be delivered in the range of prepaid amount of money, the CPU 4 accesses the content database 6, reads the data of the corresponding content, and delivers it to the personal computer 2 through the interface 7. With this content delivery, the CPU 4 generates the writing key which allows the copying of content.

The content delivery server 3 controls the personal computer 2 through the network 1, using the writing key in the delivery of content. Specifically, the CPU 4 transmits the writing key to the personal computer 2, with the content data. With the transmission, the content delivery server 3 controls the CPU 8 of the personal computer 2 such that the writing key is recorded into the writing key recording area 21 of the optical disc 1.

The CPU 8 of the personal computer 2 judges whether or not the writing key is recorded in the writing key recoding area 21, in the copying of content. From the judgment, if the writing key is recorded, it is regarded as the content delivery server 3 allowing the copying of content, and the content in the HDD 9 can be copied into the recordable area of the optical disc 1. When the copying of content is normally ended, the CPU 8 updates the delivery control information and the prepaid information which are recorded in the medium identification information (the delivery control information area) 22 and the prepaid information area 23, respectively, on the optical disc 1. By this, such an indication is recorded that the content has been already copied, in the delivery control information, and such an indication is recorded that the prepaid amount of money has been used, in the prepaid information.

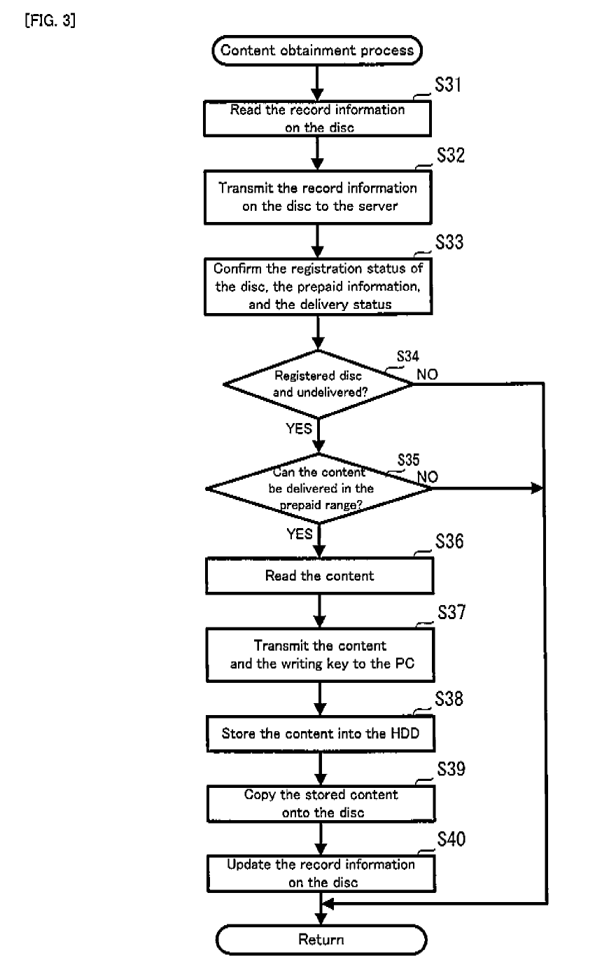

Next, with reference to FIG. 3, an explanation will be given on a content obtainment process in the content delivery system 100 in the embodiment.

(Content Obtainment Process in Embodiment)

FIG. 3 is a flowchart showing the content obtainment process in the content delivery system 100 in the embodiment. The “content obtainment” in the content obtainment process means the delivery and copying of content.

Specifically, in FIG. 3, when the optical disc 1 is set on the optical drive 11 of the personal computer 2, the optical disc 1 is detected by the controller 14, and the medium identification information, the prepaid information and the content identification information which are recorded on the optical disc 1 are read by the reading/writing device 15 (step S31), and they are transmitted to the content deliver server 3 (step S32).

On the content deliver server 3, the registration status of the optical disc 1, the prepaid information, and the delivery status of the content are read by the CPU 4 (step S33), and it is judged whether or not the disc ID is registered with reference to the disc information database 5, and it is judged whether the content has been already delivered or has not been delivered, from the delivery control information (step S34). Then, it is judged whether or not the content can be delivered in the range of prepaid amount of money, from the prepaid information (step S35). From the judgment results, if it applies to any of the three results: the disc ID is not registered, the content has been already delivered, and the content cannot be delivered in the range of prepaid amount of money (the steps S34 and S35: NO), the process is ended without the delivery of content for any of the reasons that the optical disc 1 is not allowed to deliver the content, that the content has been already delivered to the optical disc 1, and that the prepaid amount of money has been used.

On the other hand, from the judgment results, if it applies to all the three results: the disc ID is registered, the content has not been delivered, and the content can be delivered in the range of prepaid amount of money (the steps S34 and S35: YES), the content corresponding to the content identification information is read from the content database 6 (step S36), and along with this, the writing key corresponding to the read content is generated. Then, the read content and the writing key are transmitted to the personal computer 2 (step S37).

In the personal computer 2, the content is stored by the CPU 8 into the HDD 9 (step S38), and the writing key is recorded by the optical drive 11 into the writing key recording area 21 of the optical disc 1. When the storage of the content is ended, the writing key is read by the CPU 8, and the content stored in the HDD 9 is copied onto the optical disc 1 (step S39). If the copying of the content is normally ended, the delivery control information and the prepaid information are updated by the CPU 8 (step S40), and a series of content obtainment process is ended.

As described above, according to the embodiment, if the optical disc 1 is set on the personal computer 2, the disc ID, the delivery control information, the prepaid information, the content identification information, and the like, which are recorded on the optical disc 1 are transmitted to the content delivery server 3, and it is confirmed on the content delivery server 3 that the optical disc 1 is a registered disc, by virtue of the transmitted disc ID, and that the content has not been delivered with respect to the optical disc 1, by virtue of the delivery control information. Then, the content corresponding to the content identification number is delivered to the personal computer 2 in the range of prepaid amount of money indicated by the prepaid information, and the delivered content is stored into the HDD 9 on the personal computer 2, and the content stored in the HDD 9 is copied to the optical disc 1. By this, it is possible to perform the content delivery excellent in quickness and safety, and it is also possible to ensure that the optical disc 1 on which the desired content is recorded is safely delivered to a user.

Incidentally, according to the embodiment, the delivery and copying of content are allowed on the optical disc 1 having the disc ID stored in the disc information database 5; however, it may be only the delivery of content that is allowed.

Incidentally, according to the embodiment, the delivery control information and the prepaid information are updated by the CPU 8 of the personal computer 2; however, the delivery control information and the prepaid information may be updated by the CPU 4 of the content delivery server 3 controlling the CPU 8 of the personal computer 2 through the Internet 17.

Incidentally, according to the embodiment, the content delivered from the content delivery server 3 is specified by the content identification number recorded on the optical disc 1; however, a user may be able to specify one or a plurality of contents from the plurality of contents. As a situation that the user specifies the content, for example, the plurality of advertisement information associated with the plurality of contents are recorded in the advertisement recording area 25 disposed in the lead-out area on the optical disc 1, as shown in FIG. 2, and the user watches the advertisement information, thereby specifying the desired content linked to the advertisement information.

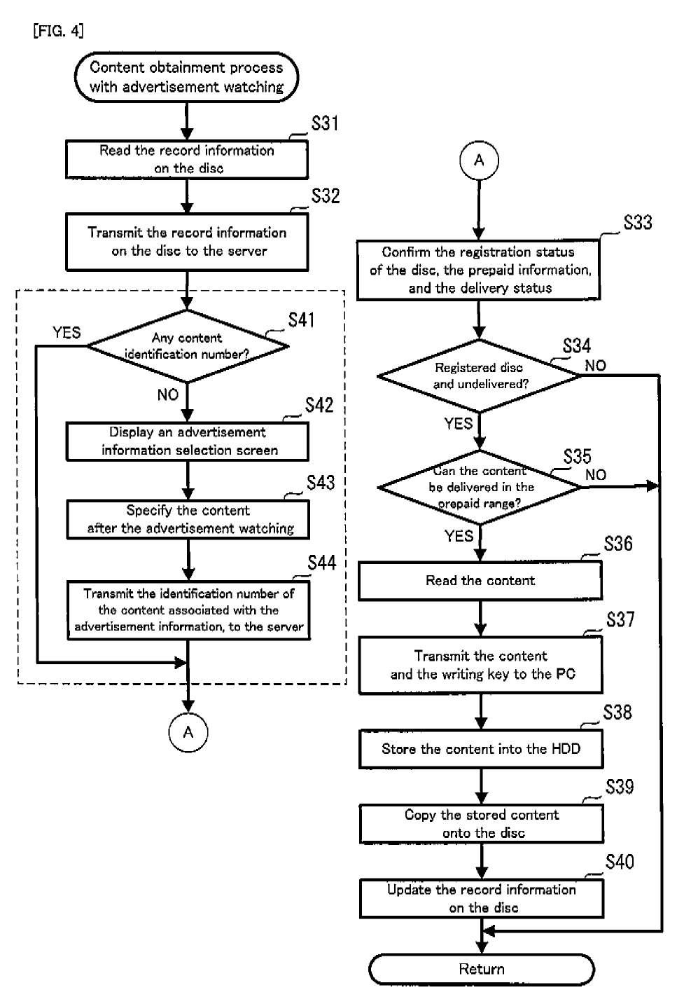

FIG. 4 is a flowchart showing a content obtainment process with advertisement watching in the content delivery system 100 in the embodiment.

Specifically in FIG. 4, if the optical disc 1 is set on the optical drive 11 in the personal computer 2, the medium identification information, the prepaid information and the content identification information which are recorded on the optical disc 1 are read (the step S31), and they are transmitted to the content delivery server 3 (the step S32). Then, it is judged whether or not there is the content identification number in the read content identification information (step S41). If there is the content identification number (the step S41: YES), the content is not specified by a user, and the content corresponding to the content identification number is delivered. On the other hand, if there is no content identification number (the step S41: NO), an advertisement information selection screen is displayed on the monitor 13 of the personal computer 2 (step S42). On the selection screen, for example, a hyperlink for displaying each of the advertisement information is added. In this manner, after the advertisement information is selected and watched by the user, the desired content is specified (step S43). The content identification number which identifies the specified content is transmitted to the content delivery server 3 (step S44).

After this, as in the content obtainment process in the embodiment, the registration status of the optical disc 1, the prepaid information, and the delivery status of the content are read on the content delivery server 3 (the step S33), and if the disc ID is registered, the content has not been delivered, and the content can be delivered in the range of prepaid amount of money (the steps S34 and S35: YES), the content specified by the user after the advertisement watching is read (step S36). The read content is transmitted to the personal computer 2, with the writing key (the step S37).

If the content is stored into the HDD 9 on the personal computer 2 (the step S38), the content stored in the HDD 9 is copied onto the optical disc 1 (the step S39). If the copying of content is normally ended, the delivery control information and the prepaid information are updated (step S40), and a series of content obtainment process with the advertisement watching is ended.

As described above, a user can obtain the desired content after selectively watching the advertisement information. Thus, the obtainment of content accompanied by the advertisement watching is extremely useful in practice.

Incidentally, in the embodiment, when the copying of content is normally ended, such an indication is recorded that the content has been already copied, in the delivery control information, and when the copying of content has failed, the above indication that it has been copied is not recorded but the copying onto the same optical disc can be performed. However, when the copying of content has failed, the copying can be also performed onto another optical disc different from the optical disc with the copying failed.

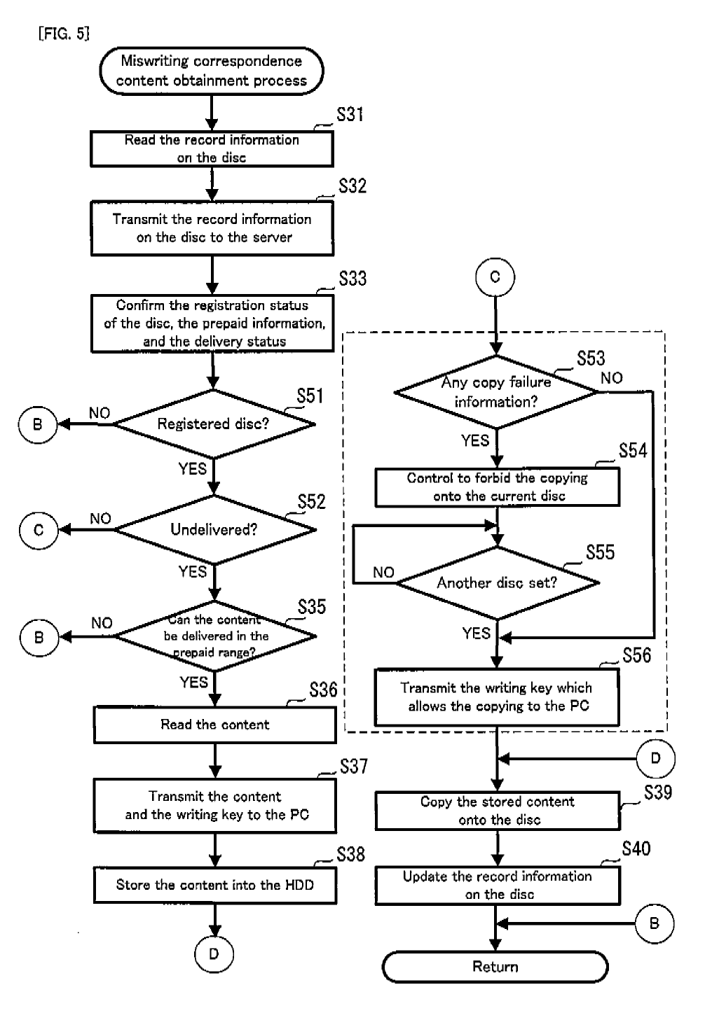

FIG. 5 is a flowchart showing a miswriting correspondence content obtainment process in the content delivery system 100 in the embodiment.

Specifically, in FIG. 5, as in the embodiment, the record information on the optical disc 1 set on the optical drive 1 on the personal computer 2, i.e. the medium identification information, the prepaid information and the content identification information, are read (the step S31), and the read record information is transmitted to the content delivery server 3 (the step S32).

Then, the registration status of the optical disc 1, the prepaid information, and the delivery status of the content are read on the content delivery server 3 (the step S33), and it is judged whether or not the disc ID is registered (step S51). If the disc ID is registered (the step S51: YES), it is judged which indication the delivery control information gives, the delivery of content or undelivery (step S52). If the content has been undelivered (the step S52: YES), it is judged whether or not the content can be delivered in the range of prepaid amount of money (the step S35), and hereinafter, the same processes as in the embodiment are performed.

On the other hand, if the content has not been undelivered, i.e. if the content has been already delivered (the step S52: NO), it is judged whether or not there is copy failure information in the delivery control information (step S53). If there is the copy failure information (the step S53: YES), the copying onto the current optical disc which is set on the optical drive 11 is forbidden, and on the monitor 13 of the personal computer 2 such an indication is displayed that the copying onto the current disc is forbidden (step S54), and such an indication is displayed that gives an instruction to set another optical disc different from the current disc. Then, on the content delivery server 3 side, another optical disc is set on the optical drive 11, and if this is detected (step S55: YES), the writing key which allows the second copying is generated and transmitted to the personal computer 2 (step S56).

On the personal computer 2, the writing key is read, and the content stored in the HOD 9 is copied onto the other optical disc (the step S39). If the copying of content is normally ended, as in the embodiment, the delivery control information and the prepaid information are updated (the step S40), and a series of miswriting correspondence content obtainment process is ended.

As described above, even if a right to copy the content obtained by prepayment is not exercised, it is possible to obtain the content, quickly and easily. Moreover, even if a user makes a false complaint about miswriting to a content provider side, the number of the optical disc 1 which allows the copying is limited to one. Thus, the content provider side can respond to the complaint without anxiety. On the other hand, the user has no benefit derived from such complaints, so in reality, this is rarely performed

The present invention is not limited to the aforementioned examples, but various changes may be made, if desired, without departing from the essence or spirit of the invention which can be read from the claims and the entire specification.

### INDUSTRIAL APPLICABILITY

The present invention can be applied to a content delivery system and method, which delivers or distributes content from a server apparatus to a client apparatus through a network such as the Internet, as well as the server apparatus and the client apparatus which constitute such a content delivery system.

1-13. (canceled)

14. A content delivery system comprising a server apparatus and a client apparatus which are included in a network; and an information recording medium which can be set on said client apparatus and which allows recording, wherein
prepaid information is recorded on the information recording medium, the prepaid information indicating at least one of a prepaid amount of money to obtain content and an indication that it has been prepaid, said client apparatus transmits the recorded prepaid information and content identification information indicating the content to said server apparatus when the information recording medium is set, said server apparatus delivers the content indicated by the transmitted content identification information to said client apparatus in a prepaid range indicated by the transmitted prepaid information, said client apparatus stores the delivered content into a storing device and further copies the stored content onto the information recording medium, medium identification information about the information recording medium is recorded on the information recording medium,
said client apparatus further transmits the recorded medium identification information to said server apparatus,
said server apparatus delivers the content if the information recording medium identified in accordance with the transmitted medium identification information is an information recording medium registered as what allows copying of the content in advance, and said server apparatus allows said client apparatus through the network to copy the stored content onto the information recording medium, and the medium identification information includes delivery control information indicating at least one of an indication that the content has been delivered and an indication that the content has been copied.

15. The content delivery system according to claim 14, wherein said client apparatus stores the delivered content into the storing device and can reproduce the stored content.

16. The content delivery system according to claim 14, wherein said server apparatus allows said client apparatus through the network to copy the stored content onto the information recording medium.

17. A content delivery system comprising a server apparatus and a client apparatus which are included in a network; and an information recording medium which can be set on said client apparatus and which allows recording, wherein prepaid information is recorded on the information recording medium, the prepaid information indicating at least one of a prepaid amount of money to obtain content and an indication that it has been prepaid, said client apparatus transmits the recorded prepaid information and content identification information indicating the content to said server apparatus when the information recording medium is set, said server apparatus delivers the content indicated by the transmitted content identification information to said client apparatus in a prepaid range indicated by the transmitted prepaid information, said client apparatus stores the delivered content into a storing device and further copies the stored content onto the information recording medium, medium identification information about the information recording medium is recorded on the information recording medium, said client apparatus further transmits the recorded medium identification information to said server apparatus, said server apparatus delivers the content if the information recording medium identified in accordance with the transmitted medium identification information is an information recording medium registered as what allows at least delivery of the content in advance out of the delivery of the content and copying of the content, and the medium identification information includes delivery control information indicating at least one of an indication that the content has been delivered and an indication that the content has been copied.

18. The content delivery system according to claim 14, wherein a plurality of advertisement information according to the content is recorded on the information recording medium, and said client apparatus can specify the content by specifying one or a plurality of advertisement out of the recorded plurality of advertisement information.

19. The content delivery system according to claim 14, wherein said client apparatus can update the recorded prepaid information in accordance with the delivery of the content.

20. The content delivery system according to claim 14, wherein said server apparatus controls said client apparatus through the network to update the recorded prepaid information in accordance with the delivery of the content.

21. A content delivery system comprising a server apparatus and a client apparatus which are included in a network; and an information recording medium which can be set on said client apparatus and which allows recording, wherein prepaid information is recorded on the information recording medium, the prepaid information indicating at least one of a prepaid amount of money to obtain content and an indication that it has been prepaid, said client apparatus transmits the recorded prepaid information and content identification information indicating the content to said server apparatus when the information recording medium is set, said server apparatus delivers the content indicated by the transmitted content identification information to said client apparatus in a prepaid range indicated by the transmitted prepaid information, said client apparatus stores the delivered content into a storing device and further copies the stored content onto the information recording medium, medium identification information about the information recording medium is recorded on the information recording medium, said client apparatus further transmits the recorded medium identification information to said server apparatus if copying of the content onto the information recording medium has failed, in a form of including failure information indicating that the copying has failed, and said server apparatus forbids said client apparatus through the network to copy the stored content onto the information recording medium identified by the medium identification information if the copying has failed in accordance with the failure information in the transmitted medium identification information, and said server apparatus allows said client apparatus through the network to copy the stored content onto another information recording medium.

22. A content delivery method in a content delivery system comprising a server apparatus and a client apparatus which are included in a network; and an information recording medium which can be set on said client apparatus and which allows recording, wherein prepaid information is recorded on the information recording medium, the prepaid information indicating at least one of a prepaid amount of money to obtain content and an indication that it has been prepaid, and said content delivery method comprises:
a first transmitting process of transmitting the recorded prepaid information and content identification information indicating the content to said server apparatus when the information recording medium is set, on said client apparatus;
a delivering process of delivering the content indicated by the transmitted content identification information to said client apparatus in a prepaid range indicated by the transmitted prepaid information, on said server apparatus;
a storing process of storing the delivered content into a storing device, on said client apparatus; a copying process of copying the stored content onto the information recording medium, on said client apparatus; medium identification information about the information recording medium being recorded on the information recording medium, a second transmitting process of the recorded medium identification information to said server apparatus, on said client apparatus; and an allowing process of delivering the content if the information recording medium identified in accordance with the transmitted medium identification information is an information recording medium registered as what allows copying of the content in advance, and of allowing said client apparatus through the network to copy the stored content onto the information recording medium, on said server apparatus, and the medium identification information including delivery control information indicating at least one of an indication that the content has been delivered and an indication that the content has been copied.

23. A server apparatus in a content delivery system comprising said server apparatus and a client apparatus which are included in a network; and an information recording medium which can be set on said client apparatus and which allows recording, wherein prepaid information is recorded on the information recording medium, the prepaid information indicating at least one of a prepaid amount of money to obtain content and an indication that it has been prepaid, said client apparatus transmits the recorded prepaid information and content identification information indicating the content to said server apparatus when the information recording medium is set, said server apparatus delivers the content indicated by the transmitted content identification information to said client apparatus in a prepaid range indicated by the transmitted prepaid information, said client apparatus stores the delivered content into a storing device and further copies the stored content onto the information recording medium, medium identification information about the information recording medium is recorded on the information recording medium, said client apparatus further transmits the recorded medium identification information to said server apparatus, said server apparatus delivers the content if the information recording medium identified in accordance with the transmitted medium identification information is an information recording medium registered as what allows copying of the content in advance, and said server apparatus allows said client apparatus through the network to copy the stored content onto the information recording medium, and the medium identification information includes delivery control information indicating at least one of an indication that the content has been delivered and an indication that the content has been copied.

24. A client apparatus in a content delivery system comprising a server apparatus and said client apparatus which are included in a network; and an information recording medium which can be set on said client apparatus and which allows recording, wherein prepaid information is recorded on the information recording medium, the prepaid information indicating at least one of a prepaid amount of money to obtain content and an indication that it has been prepaid, said client apparatus transmits the recorded prepaid information and content identification information indicating the content to said server apparatus when the information recording medium is set, said server apparatus delivers the content indicated by the transmitted content identification information to said client apparatus in a prepaid range indicated by the transmitted prepaid information, said client apparatus stores the delivered content into a storing device and further copies the stored content onto the information recording medium, medium identification information about the information recording medium is recorded on the information recording medium, said client apparatus further transmits the recorded medium identification information to said server apparatus, said server apparatus delivers the content if the information recording medium identified in accordance with the transmitted medium identification information is an information recording medium registered as what allows copying of the content in advance, and said server apparatus allows said client apparatus through the network to copy the stored content onto the information recording medium, and the medium identification information includes delivery control information indicating at least one of an indication that the content has been delivered and an indication that the content has been copied.
